(19) United States
(12) Patent Application Publication
(10) Pub. No.: US 2023/0098534 A1
(43) Pub. Date: Mar. 30, 2023

(54) DEPOSITION APPARATUS AND DEPOSITION PRODUCT MANUFACTURING METHOD

(71) Applicant: HOJITSU SEIKO CO., LTD., Guifu (JP)

(72) Inventor: Yukio Imaizumi, Gifu (JP)

(73) Assignee: HOJITSU SEIKO CO., LTD., Gifu (JP)

(21) Appl. No.: 18/070,693

(22) Filed: Nov. 29, 2022

Related U.S. Application Data
(63) Continuation of application No. PCT/JP2021/034295, filed on Sep. 17, 2021.

(30) Foreign Application Priority Data
Nov. 24, 2020 (JP) 2020-194075

(51) Int. Cl. C23C 24/04; B05B 13/04; B05B 13/02

(52) U.S. Cl. CPC C23C 24/04; B05B 13/0415; B05B 13/0278; B05B 13/0431

(57) ABSTRACT

A deposition apparatus includes: discharge nozzles arranged at predetermined intervals in a processing compartment in a deposition chamber, wherein each of the discharge nozzles comprises a discharge port that discharges aerosolized particulates toward a corresponding surface treatment object; linear motor single-axis robots arranged at predetermined intervals in a direction perpendicular to a nozzle arrangement direction; and nozzle head units that each adjust a mutual distance between the discharge port and a surface of the corresponding surface treatment object based on a shape of the corresponding surface treatment object, the nozzle head units moving along the nozzle arrangement direction, and the nozzle head units being arranged in each of the linear motor single-axis robots.

### CROSS-REFERENCE TO THE RELATED APPLICATION

The present application is a continuation of International Application No. PCT/JP2021/034295, which claims priority from Japanese Patent Application No. 2020-194075 filed Nov. 24, 2020, both of which are incorporated herein by reference.

### BACKGROUND

### Technical Field

The present disclosure relates to a deposition apparatus to which an aerosol deposition method is applied.

### Description of Related Art

As for the deposition apparatus, for example, as shown in Patent Literature 1, a deposition apparatus using an aerosol deposition method (hereinafter, also called the AD method) has been proposed. For example, as shown in FIG. 5 in Patent Literature 1, such a deposition apparatus includes: a chamber that has an internal pressure lower than the internal pressure of an aerosol making container, described later; a stage which is arranged in the chamber movably in the back and forth direction and the lateral direction and to which a substrate as a processing target object (workpiece) to be subjected to a surface treatment is attached; two nozzles which are arranged in the chamber so that two extension lines intersect with each other and through which an aerosol is sprayed toward a surface of the processing target object; two aerosol making containers that supply the aerosol to the two respective nozzles; and two gas cylinders that supply carrier gas to the two respective aerosol making containers.

According to this configuration, for example, when the aerosol is sprayed toward the surface of the substrate from the two nozzles at the same time, a film having a predetermined film thickness is formed on the surface of the substrate.

### PATENT LITERATURE

[Patent Literature 1] Japanese Patent No. 6347189

In recent years, mass production of a plurality of processing target objects to be subjected to a surface treatment through the AD method has been demanded. However, when the deposition apparatus as described above is used in such a case, a configuration where a single substrate is arranged on the stage requires an attachment and detachment operation for each substrate. Accordingly, the mass productivity of the processing target objects to be subjected to the surface treatment is insufficient, which increases the manufacturing cost of the processing target objects and the manufacturing cost of the deposition apparatus.

### SUMMARY

One or more embodiments of the present disclosure provide a deposition apparatus and a deposition product manufacturing method to which the aerosol deposition method is applied and which can reduce the manufacturing cost of the processing target objects and the manufacturing cost of the deposition apparatus by increasing the mass productivity of the processing target objects to be subjected to the surface treatment.

A deposition apparatus according to one or more embodiments of the present disclosure includes: a plurality of discharge nozzles that are arranged at predetermined intervals in a processing compartment in a deposition chamber, and discharge aerosolized particulates toward surface treatment objects; and mutual distance adjustment means (i.e., nozzle head units) for adjusting a mutual distance between a discharge port of each of the discharge nozzles and a surface, of a corresponding surface treatment object of the surface treatment objects, to be subjected to a surface treatment, in conformity with a shape of the surface treatment object.

The mutual distance adjustment means may include: discharge nozzle supporters that support the discharge nozzles so that directions of the discharge ports of the discharge nozzles with respect to the surface of the surface treatment object to be subjected to the surface treatment are able to be changed; and a Z-axis stage that elevatably supports the surface treatment object with respect to the discharge port of the discharge nozzle. The mutual distance adjustment means may include nozzle head mechanisms that are movable along an arrangement direction (or a nozzle arrangement direction) of the plurality of discharge nozzles. The plurality of nozzle head mechanisms may be provided for a plurality of respective linear motor single-axis robots arranged at predetermined intervals in a direction substantially orthogonal to the arrangement direction of the discharge nozzles.

At least one XY-axis stage that supports at least one Z-axis stage movably along an arrangement direction of the plurality of discharge nozzles may be further provided.

A deposition product manufacturing method according to one or more embodiments of the present disclosure includes: arranging a plurality of discharge nozzles at predetermined intervals in a processing compartment in a deposition chamber, and discharging, by the discharge nozzles, aerosolized particulates toward surface treatment objects to apply a surface treatment to the surface treatment objects; and adjusting, by mutual distance adjustment means, a mutual distance between a discharge port of each of the discharge nozzles and a surface, of a corresponding surface treatment object of the surface treatment objects, to be subjected to a surface treatment, in conformity with a shape of the surface treatment object.

The mutual distance adjustment means may include: discharge nozzle supporters that support the discharge nozzles so that directions of the discharge ports of the discharge nozzles with respect to the surface of the surface treatment object to be subjected to the surface treatment are able to be changed; and a Z-axis stage that elevatably supports the surface treatment object with respect to the discharge port of the discharge nozzle. The mutual distance adjustment means may include nozzle head mechanisms that are movable along an arrangement direction of the plurality of discharge nozzles.

In the deposition apparatus, and the deposition product manufacturing method according to one or more embodiments of the present disclosure, a plurality of discharge nozzles, and mutual distance adjustment means are provided. The discharge nozzles are arranged at predetermined intervals in a processing compartment in a deposition chamber, and discharge aerosolized particulates toward surface treatment objects. The mutual distance adjustment means adjusts the mutual distance between a discharge port of each discharge nozzle and a surface of the corresponding surface treatment object to be subjected to a surface treatment, in conformity with the shape of the surface treatment object. Consequently, the mass productivity of the processing target objects to be subjected to the surface treatment can be improved, which can reduce the manufacturing cost of the processing target objects and the manufacturing cost of the deposition apparatus.

### BRIEF DESCRIPTION OF DRAWINGS

FIG. 1 is a configuration diagram schematically showing an example of a deposition apparatus according to one or more embodiments of the present disclosure.

FIG. 2 is a plan view showing Z stages and a plurality of workpieces arranged on a fixing table shown in FIG. 1.

FIG. 3 is a configuration diagram schematically showing a main part of another example of a deposition apparatus according to one or more embodiments of the present disclosure.

FIG. 4 shows the configuration of a nozzle head mechanism used in the example shown in FIG. 3.

FIG. 5A is sectional view showing other examples of workpieces to which a surface treatment is applied by the deposition apparatus.

FIG. 5B is sectional view showing other examples of workpieces to which a surface treatment is applied by the deposition apparatus.

FIG. 6 is a configuration diagram schematically showing a main part of still another example of a deposition apparatus according to one or more embodiments of the present disclosure.

### DETAILED DESCRIPTION OF EMBODIMENTS

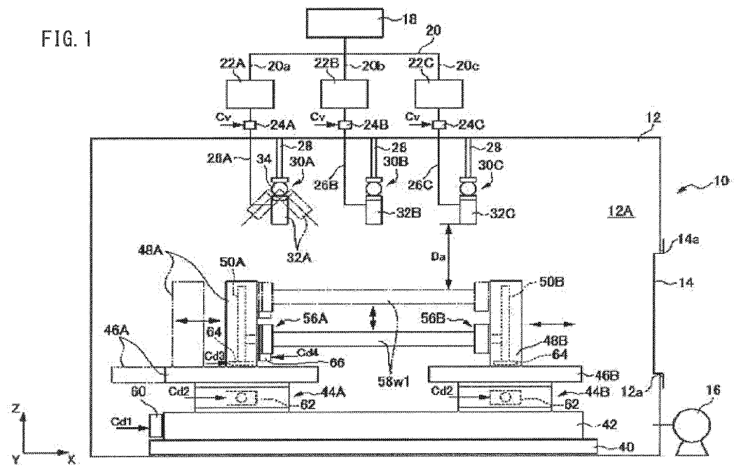

FIG. 1 schematically shows the configuration of an example of a deposition apparatus according to one or more embodiments of the present disclosure.

The deposition apparatus includes, as main elements: a plurality of aerosol generators 22A, 22B and 22C; a gas supply path 20; a gas cylinder 18; and a deposition chamber 10. For deposition using the aerosol deposition method, in each of the aerosol generators 22A, 22B and 22C, a gas (e.g., air) and particulates made of a predetermined material (e.g., ceramic material powder etc.) are mixed, and the particulates are aerosolized. The gas cylinder 18 supplies the aerosol generators 22A, 22B and 22C with a gas (e.g., air) or an inert gas that has a predetermined pressure, respectively through branch paths 20a, 20b and 20c of the gas supply path 20. In the deposition chamber 10, deposition is performed on a surface of a surface treatment object (hereinafter also called a workpiece) that is to become a deposition product and described later, with the aforementioned aerosolized particulates.

One ends of the branch paths 20a, 20b and 20c communicate with the inlets of the respective aerosol generators 22A, 22B and 22C. One ends of aerosol supply paths 26A, 26B and 26C that supply aerosolized particulates communicate with the outlets of the respective aerosol generators 22A, 22B and 22C. Discharge nozzles 32A, 32B and 32C arranged in the deposition chamber 10 communicate with the other ends of the respective aerosol supply paths 26A, 26B and 26C. The aerosol supply paths 26A, 26B and 26C are respectively provided with flow rate control valves 24A, 24B and 24C that adjust the flow rates of aerosolized particulates. The flow rate control valves 24A, 24B and 24C are each controlled based on a control signal Cv from a control unit, which is not shown.

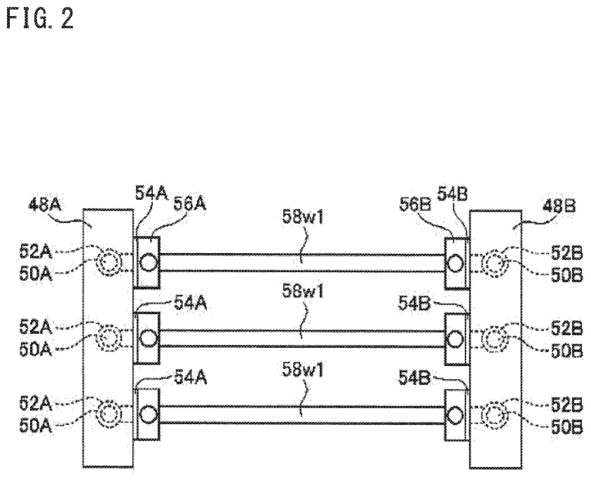

The discharge nozzles 32A, 32B and 32C, an XY-axis stage arranged on a predetermined base 40, a first Z-axis stage 48A (see FIG. 2) and a second Z-axis stage 48B (see FIG. 2) are arranged, as main elements, in a processing compartment 12A in a case 12 of the deposition chamber 10. At three sites on a ceiling part of the case 12, respective support shafts 28 are arranged in line at predetermined intervals along an X-coordinate axis in FIG. 1. Housings 34 are fixed to the lower ends of the respective support shafts 28. The discharge nozzles 32A, 32B and 32C are respectively supported via spherical bearings 30A, 30B and 30C in the housings 34. The first Z-axis stage 48A elevatably supports workpiece attachment jigs 56A for supporting one ends of workpieces 58W1, and rotatably supports the workpiece attachment jigs 56A and the workpieces 58W1. The second Z-axis stage 48B elevatably supports workpiece attachment jigs 56B for supporting the other ends of the workpieces 58W1, and rotatably supports the workpiece attachment jigs 56B and the workpieces 58W1. Note that in FIG. 1, the X-coordinate axis is configured to be parallel with the moving direction of a movable table of a lower stage 42, described later, the Y-coordinate axis is configured to be orthogonal to the X-coordinate axis, and be parallel with the moving direction of a fixing table 46A coupled to a movable table of an upper stage 44A, described later. The Z-coordinate axis is configured to be orthogonal to the X-coordinate axis and the Y-coordinate axis.

The discharge nozzles 32A, 32B and 32C are fixed at lower predetermined positions apart by a predetermined distance from the ceiling part in the case 12 toward the first Z-axis stage 48A and the second Z-axis stage 48B. The distance Da from the discharge ports of the discharge nozzles 32A, 32B and 32C arranged in line along the X-coordinate axis to the surface of the workpiece 58W1 to be subjected to the surface treatment is set to be a predetermined distance in conformity with the shape of the workpiece 58W1. The workpiece 58W1 is, for example, a cylindrical metal object having a predetermined length along the central axis. The discharge ports of the discharge nozzles 32A, 32B and 32C face, for example, respective positions immediately above the surface of the workpiece 58W1 to be subjected to the surface treatment that is at the very end most apart along the Y-coordinate axis in FIG. 2. The discharge nozzles 32A, 32B and 32C are respectively supported via the spherical bearings 30A, 30B and 30C in the housings 34. Accordingly, the directions of the discharge ports of the discharge nozzles 32A, 32B and 32C are not necessarily limited to the downward direction shown in FIG. 1. For example, as indicated by chain double-dashed lines in FIG. 1, the directions can be changed in a range of about 45° (swing half angle) in both the directions, i.e., in a range of about 90°, with respect to the central axis line on the plane including the Z-coordinate axis and the X-coordinate axis. The discharge nozzles 32A, 32B and 32C are supplied with aerosolized particulates having a predetermined pressure respectively through the aerosol supply paths 26A, 26B and 26C.

The XY-axis stage includes the lower stage 42, the upper stages 44A and 44B, the fixing table 46A, and the fixing table 46B. The lower stage 42 includes a fixing table fixed to the base 40, and a movable table. The upper stages 44A and 44B include fixing tables coupled to the movable table of the lower stage 42. The fixing table 46A is coupled to the movable table arranged movably to the upper stage 44A. The fixing table 46B is coupled to the movable table arranged movably to the upper stage 44B.

Note that the lower stage 42 includes a drive motor 60 that drives the movable table through a ball screw. The drive motor 60 is, for example, a servo motor or a stepping motor. The upper stages 44A and 44B arranged to face each other along the X-coordinate axis include drive motors 62 that drive the respective movable tables through the ball screws. The drive motor 62 is, for example, a servo motor or a stepping motor. The drive motors 60 and 62 are respectively controlled based on control signals Cd1 and Cd2 from the control unit, which is not shown.

Furthermore, a Z-axis stage 48A is provided at a center part of the fixing table 46A of the upper stage 44A so as to be movable on the fixing table 46A along the X-coordinate axis. A Z-axis stage 48B is provided at a center part of the fixing table 46B of the upper stage 44B so as to be movable on the fixing table 46B along the X-coordinate axis in a state of facing the Z-axis stage 48A. As described above, the Z-axis stage 48A and the Z-axis stage 48B are provided so as to be close to or apart from each other. Accordingly, any of workpieces 58W1 having different lengths in the axial direction can be arranged between the Z-axis stage 48A and the Z-axis stage 48B. For example, in a case where the workpiece has a length longer than the length of the workpiece 58W1 along the axial direction shown in FIG. 1, the fixing table 46B is moved to the left in FIG. 1 so that the fixing table 46B supports one end of the workpiece along the X-coordinate axis as indicated by the chain double-dashed lines in FIG. 1.

As shown in FIG. 2, the Z-axis stage 48A is provided with workpiece elevating mechanisms to be parallel with each other at three sites at predetermined intervals along the Y-coordinate axis. Each workpiece elevating mechanism includes a workpiece elevating slider 52A, a ball/screw shaft 50A that raises and lowers the workpiece elevating slider 52A, and a drive motor 64 that rotates the ball/screw shaft 50A.

The workpiece attachment jig 56A is coupled to the coupling end of each workpiece elevating slider 52A via a bearing, not shown. The workpiece attachment jig 56A is rotated by a screw gear mechanism (or a worm gear) 54A that includes screw gears. The workpiece attachment jig 56A has a hole part into which one end of the workpiece 58W1 is fitted. The one end of the workpiece 58W1 fitted into the hole part is fixed to the workpiece attachment jig 56A with a hexagon socket set screw provided for the workpiece attachment jig 56A. The output shaft of a drive motor 66 is joined to the input shaft of the screw gear mechanism (or worm gear) 54A described above.

As shown in FIG. 2, the Z-axis stage 48B is provided with workpiece elevating mechanisms to be parallel with each other at three sites at predetermined intervals along the Y-coordinate axis. Each workpiece elevating mechanism includes a workpiece elevating slider 52B, a ball/screw shaft 50B that raises and lowers the workpiece elevating slider 52B, and a drive motor 64 that rotates the ball/screw shaft 50B.

The workpiece attachment jig 56B is coupled to the coupling end of each workpiece attachment jig 56B. The workpiece attachment jig 56B is rotated via a bearing supporter 54B. The workpiece attachment jig 56B has a hole part into which the other end of the workpiece 58W1 is fitted. The other end of the workpiece 58W1 fitted into the hole part is fixed to the workpiece attachment jig 56B with a hexagon socket set screw provided for the workpiece attachment jig 56B. The drive motors 64 and 66 are respectively controlled based on control signals Cd3 and Cd4 from the control unit, which is not shown.

Consequently, mutual distance adjustment means for adjusting the mutual distance between the discharge port of the discharge nozzle and the surface of the surface treatment object to be subjected to the surface treatment in conformity with the shape of the surface treatment object, includes the spherical bearings 30A, 30B and 30C in the housings 34 described above, and the Z-axis stages 48A and 48B that include the workpiece attachment jigs 56A and 56B.

As shown in FIG. 1, the case 12 of the deposition chamber 10 is provided with an operation door 14 for an operation of changing the discharge directions of the discharge nozzles 32A, 32B and 32C, or an operation and the like of attaching the workpiece 58W1 to the workpiece attachment jigs 56A and 56B. The operation door 14 is sealed with a sealing member 14a around an opening part 12a of the case 12. The inside pressure of the processing compartment 12A in the deposition chamber 10 is aspirated by a vacuum pump 16 that communicates with the deposition chamber 10, and the pressure is reduced to a predetermined vacuum degree lower than the pressures in the aerosol generators 22A, 22B and 22C.

According to such a configuration, first, in a state where the directions of the discharge ports of the discharge nozzles 32A, 32B and 32C are in the Z-coordinate axis, three workpieces 58W1 are attached to the workpiece attachment jigs 56A and 56B. Subsequently, the three workpieces 58W1 are raised by the workpiece elevating mechanism until the distance from the discharge ports of the discharge nozzles 32A, 32B and 32C to the surface of the workpiece 58W1 to be subjected to the surface treatment reaches the distance Da as indicated by chain double-dashed lines in FIG. 1, and then are stopped. Next, the flow rate control valves 24A, 24B and 24C are each subjected to drive control based on the control signal Cv from the control unit. The discharge nozzles 32A, 32B and 32C simultaneously start to spray aerosolized particulates to the first workpiece 58W1 at predetermined timing. Meanwhile, the drive motor 60 is controlled based on the control signal Cd1 from the control unit. The movable table of the lower stage 42 is moved in a predetermined range at a predetermined movement speed along the X-coordinate axis. At this time, the three workpieces 58W1 are rotated at a predetermined rotation speed. Subsequently, after the surface treatment on the first workpiece 58W1 is completed, the drive motor 62 is controlled based on the control signal Cd2 from the control unit so that the second workpiece 58W1 reaches positions immediately below the discharge nozzles 32A, 32B and 32C, and the movable table of the upper stage 44A is moved along the Y-coordinate axis. Subsequently, similar to the surface treatment on the first workpiece 58W1, the movable table of the lower stage 42 is moved in the predetermined range at a predetermined movement speed along the X-coordinate axis. Subsequently, after the surface treatment on the second workpiece 58W1 is completed, the drive motor 62 is controlled based on the control signal Cd2 from the control unit so that the third workpiece 58W1 reaches positions immediately below the discharge nozzles 32A, 32B and 32C, and the movable table of the upper stage 44A is moved along the Y-coordinate axis. After the movable table of the lower stage 42 is moved at the predetermined movement speed in the predetermined range along the X-coordinate axis and then the surface treatment on the third workpiece 58W1 is finished, spraying of the aerosolized particulates through the discharge nozzles 32A, 32B and 32C is stopped, based on the control signal Cv from the control unit. Thus, the surface treatment on the three workpieces 58W1 is finished. Consequently, in comparison with the deposition apparatus as described in Patent Literature 1, the mass productivity of processing target objects to be subjected to surface treatment using the aerosol deposition method can be improved, and the manufacturing cost of the processing target objects and the manufacturing cost of the deposition apparatus are reduced.

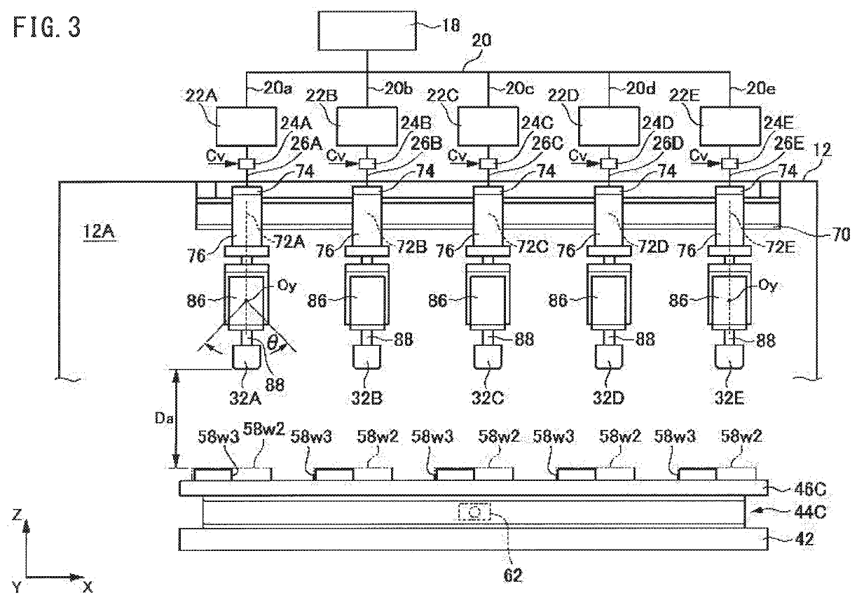

In the example described above, the distance from the discharge ports of the discharge nozzles 32A, 32B and 32C to the surface of the workpiece 58W1 to be subjected to the surface treatment is position-adjusted to the predetermined distance Da by the workpiece elevating mechanisms of the Z-axis stages 48A and 48B. However, there is no limitation to such an example. For example, as shown in FIG. 3, the deposition apparatus may include the discharge nozzles 32A, 32B, 32C, 32D and 32E arranged at the lowermost end, instead of the Z-axis stages 48A and 48B, and may include a plurality of nozzle head mechanisms that can adjust the relative positions of the discharge ports of the discharge nozzles 32A, 32B, 32C, 32D and 32E to a workpiece 58W2.

FIG. 3 schematically shows main parts of another example of a deposition apparatus according to one or more embodiments of the present disclosure.

Note that in FIG. 3, the same components as the components in the example shown in FIG. 1 are assigned the same symbols. Their redundant description is omitted.

Similar to the example shown in FIG. 1, the deposition apparatus includes, as main elements: a plurality of aerosol generators 22A, 22B, 22C, 22D and 22E; a gas supply path 20; a gas cylinder 18; and a deposition chamber 10. For deposition using the aerosol deposition method, in each of the aerosol generators 22A, 22B, 22C, 22D and 22E, a gas (e.g., air) and particulates made of predetermined material (e.g., ceramic material powder etc.) are mixed, and the particulates are aerosolized. The gas cylinder 18 supplies the aerosol generators 22A, 22B, 22C, 22D and 22E with a gas (e.g., air) or an inert gas that has a predetermined pressure, respectively through branch paths 20a, 20b, 20c, 20d and 20e of the gas supply path 20. In the deposition chamber 10, deposition is performed on a surface of a surface treatment object (hereinafter also called a workpiece) with the aforementioned aerosolized particulates.

One ends of the branch paths 20a, 20b, 20c, 20d and 20e communicate with the inlets of the respective aerosol generators 22A, 22B, 22C, 22D and 22E. One ends of aerosol supply paths 26A, 26B, 26C, 26D and 26E that supply aerosolized particulates communicate with the outlets of the respective aerosol generators 22A, 22B, 22C, 22D and 22E. After-mentioned discharge nozzles 32A, 32B, 32C, 32D and 32E arranged in the deposition chamber 10 communicate with the other ends of the respective aerosol supply paths 26A, 26B, 26C, 26D and 26E. The aerosol supply paths 26A, 26B, 26C, 26D and 26E are respectively provided with flow rate control valves 24A, 24B, 24C, 24D and 24E that adjust the flow rates of aerosolized particulates. The flow rate control valves 24A, 24B, 24C, 24D and 24E are each controlled based on a control signal Cv from a control unit, which is not shown.

A flat core linear motor (linear motor single-axis robot) 70, a plurality of nozzle head mechanisms, discharge nozzles 32A, 32B, 32C, 32D and 32E, and an XY-axis stage arranged on a predetermined base are arranged, as main elements, in the processing compartment 12A in the case 12 of the deposition chamber 10. The flat core linear motor 70 is supported by a back surface part of the case 12. The nozzle head mechanisms are supported by respective coil sliders 72A, 72B, 72C, 72D and 72E of the flat core linear motor 70. The discharge nozzles 32A, 32B, 32C, 32D and 32E are connected to T-shaped joints 88 of the respective nozzle head mechanisms. Note that in FIG. 3, the X-coordinate axis is configured to be parallel with the moving direction of a movable table of a lower stage 42, the Y-coordinate axis is configured to be orthogonal to the X-coordinate axis, and be parallel with the moving direction of a fixing table 46C coupled to a movable table of an upper stage 44C, described later. The Z-coordinate axis is configured to be orthogonal to the X-coordinate axis and the Y-coordinate axis. The XY-axis stage includes: the lower stage 42 that includes a fixing table fixed to the base, and a movable table; the upper stage 44C that includes a fixing table coupled to the movable table of the lower stage 42; and the fixing table 46C coupled to the movable table movably arranged to the upper stage 44C.

For example, five workpieces 58W2 are fixed in line at predetermined intervals along the X-coordinate axis on a workpiece support surface of the fixing table 46C via jigs, which are not shown.

The flat core linear motor (linear motor single-axis robot) 70 includes, for example: a stator (magnet plate) that is provided on the inside of the guide rails but is not shown; the plurality of sliders 72A, 72B, 72C, 72D and 72E movably arranged along the guide rails; a plurality of magnetic heads that electromagnetically detect the positions of the coil sliders 72A to 72E with respect to a linear encoder scale (magnetic scale) provided on the guide rail; and a controller (not shown) that drives and controls the linear motor.

The plurality of coil sliders 72A, 72B, 72C, 72D and 72E are arranged at predetermined intervals corresponding to the five respective workpieces 58W2, and are movable in both the directions along the X-coordinate axis.

The plurality of nozzle head mechanisms have the same configuration. Accordingly, the nozzle head mechanism coupled to the coil slider 72A is typically described.

The nozzle head mechanism as the mutual distance adjustment means includes, as main elements: an electric cylinder 76 with a shaft guide; a stepping motor 82 with a reducer; a stepping motor 86 with a reducer; and a discharge nozzle 32A. The electric cylinder 76 with the shaft guide is supported by a coupling surface 72 as of the coil slider 72A. The stepping motor 82 is supported by a motor bracket 80. The motor bracket 80 is coupled to a coupling end 78 coupled to one end of a rod 76S of an electric cylinder 76. The stepping motor 86 with the reducer is supported by a swing arm 84. The swing arm 84 is coupled to an output shaft 82S of the stepping motor 82. In a state where an output shaft 82S of the stepping motor 82 is oriented in a direction orthogonal to the arrangement direction of the discharge nozzles and a vertical direction of the deposition apparatus. The discharge nozzle 32A is coupled to the lower end of the T-shaped joint 88. The upper end of the T-shaped joint 88 is coupled to the output shaft of the stepping motor 86. Each of the nozzle head mechanisms is configured to be capable of changing a direction of the discharge port by rotating each of the discharge nozzles 32A, 32B, 32C, 32D and 32E about the output shaft of the stepping motor 82 by the operation of the stepping motor 82.

The rod 76S of the electric cylinder 76 with the shaft guide is coupled to the output shaft of a stepping motor 74. When the stepping motor 74 is in an operation state, the rod 76S lowers the motor bracket 80 so as to be close to the workpiece 58W2 and raises this bracket so as to be apart from the workpiece 58W2 along the Z-coordinate axis. The stepping motor 74, the stepping motor 82 and the stepping motor 86 are respectively controlled by control signals Cd5, Cd6 and Cd7 from the control unit, not shown.

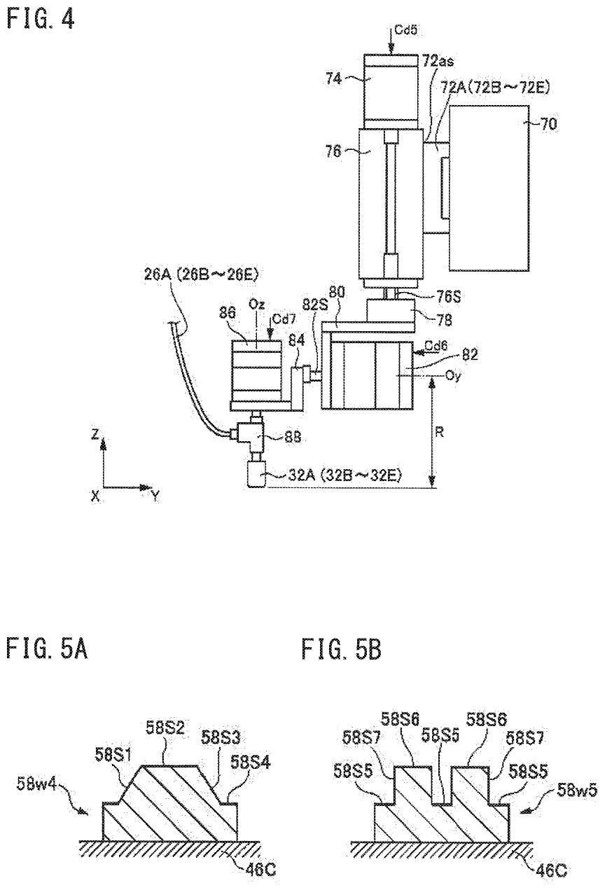

The rotational axis of the coupling end of the swing arm 84 is arranged concentrically on the rotational central axis line Oy of the output shaft 82S of the stepping motor 82 in FIG. 4. The coupling end of the swing arm 84 is configured to be rotatable about the rotational central axis line Oy in a range of a predetermined circumferential angle. The rotational central axis line Oy is configured to be substantially parallel with the Y-coordinate axis.

A motor supporter of the swing arm 84 that supports the reducer of the stepping motor 86 with this reducer is formed to be parallel with the rotational central axis line Oy. The output shaft of the stepping motor 86 with the reducer protrudes downward along the Z-coordinate axis through a through-hole of the motor supporter, and is coupled to the upper end of the T-shaped joint 88.

Accordingly, when the stepping motor 86 with the reducer is in the operation state, the T-shaped joint 88 and the discharge nozzle 32A are rotatable about the rotational central axis line Oz of the output shaft of the stepping motor 86 with the reducer in a range of the predetermined circumferential angle.

Consequently, when the stepping motor 82 is in the operation state, the swing arm 84, which is accompanied by the T-shaped joint 88 and the discharge nozzle 32A, is rotatable about the rotational central axis line Oy in the range of the predetermined circumferential angle on a plane formed by the X-coordinate axis and the Z-coordinate axis. Thus, the discharge nozzle 32A is swingable in a predetermined angle range θ, e.g., 180°. Accordingly, the trajectory drawn by the discharge port of the swinging discharge nozzle 32A is a circular arc about the rotational central axis line Oy with a curvature radius R. Consequently, for example, the surface treatment is applicable, using the discharge nozzle 32A, also to the surface of a groove of a workpiece that internally includes a grove that has a substantially U-shape having a curvature radius exceeding the curvature radius R.

According to such a configuration, first, in a state where the directions of the discharge ports of the discharge nozzles 32A to 32E are in the Z-coordinate axis, workpieces 58W2 are attached to the workpiece support surface of the fixing table 46C via workpiece attachment jigs (not shown). Subsequently, the rod 76S of the electric cylinder 76 with the shaft guide is lowered until the distance from the discharge ports of the discharge nozzles 32A to 32E to the surface treatment target surface of the workpiece 58W2 to be subjected to the surface treatment reaches the distance Da.

Next, the flow rate control valves 24A to 24E are each subjected to drive control based on the control signal Cv from the control unit. The discharge nozzles 32A to 32E simultaneously start to spray aerosolized particulates to each workpiece 58W2 at predetermined timing. Meanwhile, the drive motor 60 is controlled based on the control signal Cd1 from the control unit. The movable table of the lower stage 42 is moved in a predetermined range at a predetermined movement speed along the X-coordinate axis. Thus, the surface treatment on the five workpieces 58W2 is finished. Consequently, in comparison with the deposition apparatus as described in Patent Literature 1, the mass productivity of processing target objects to be subjected to surface treatment using the aerosol deposition method can be improved, and the manufacturing cost of the processing target objects and the manufacturing cost of the deposition apparatus are reduced.

Note that after the surface treatment on the five workpieces 58W2 are finished, for example, as indicated by solid lines in FIG. 3, five workpieces 58W3 each having a smaller dimension than the dimension of the workpiece 58W2 along the X-coordinate axis are attached in line to the workpiece support surface of the fixing table 46C via jigs (not shown) along the X-coordinate axis. In this case, the discharge start positions of the discharge nozzles 32A to 32E to the workpieces 58W3 can be easily adjusted by deviating the initial positions of the coil sliders 72A, 72B, 72C, 72D and 72E in the X-coordinate axis in the left direction in FIG. 3, or by deviating the movement start initial position of the fixing table 46C in the right direction.

Furthermore, as shown in FIG. 5A, the surface treatment target outer surface of a workpiece 58W4 attached to the workpiece support surface of the fixing table 46C includes: a flat surface 58S2; a flat skirt surface 58S4 having a difference in height from the flat surface 58S2; and a pair of inclined surfaces 58S1 and 58S3 that couple the flat surface 58S2 to the skirt surface 58S4. In this case, as described above, the rod 76S of the electric cylinder 76 with the shaft guide is lowered until the distance from the discharge ports of the discharge nozzles 32A to 32E to the surface treatment target flat surface 58S2 of the workpiece 58W4 to be subjected to the surface treatment reaches a predetermined distance, and the rod 76S of the electric cylinder 76 with the shaft guide is further lowered until the distance from the discharge ports of the discharge nozzles 32A to 32E to the surface treatment target skirt surface 58S4 of the workpiece 58W4 to be subjected to the surface treatment reaches a predetermined distance. Subsequently, in a case where the surface treatment is applied to any of the pair of inclined surfaces 58S1 and 58S3, as described above, in a state where the swing arm 84, accompanied by the T-shaped joint 88 and the discharge nozzle 32A, is rotated in a range of the predetermined circumferential angle about the rotational central axis line Oy in the directions opposite to each other, the discharge nozzles 32A to 32E simultaneously spray aerosolized particulates to the respective workpieces 58W4 at predetermined timing.

Further alternatively, as shown in FIG. 5B, a surface treatment target outer surface of a workpiece 58W5 attached to the workpiece support surface of the fixing table 46C includes: two upper end surfaces 58S6 formed at a predetermined interval; a lower end surface 58S5 that is between the two upper end surfaces 58S6 and has a difference in height; and lower end surfaces 58S5 formed at the opposite ends of the workpiece 58W5 on the common plane with the lower end surface 58S5. In this case, the rod 76S of the electric cylinder 76 with the shaft guide is lowered until the distance from the discharge ports of the discharge nozzles 32A to 32E to the surface treatment target upper end surfaces 58S6 of the workpiece 58W5 to be subjected to the surface treatment reaches a predetermined distance, and the rod 76S of the electric cylinder 76 with the shaft guide is further lowered until the distance from the discharge ports of the discharge nozzles 32A to 32E to the surface treatment target lower end surfaces 58S5 of the workpiece 58W5 to be subjected to the surface treatment reaches a predetermined distance.

Subsequently, in a case where the surface treatment is applied to outer surfaces 58S7 orthogonal to the upper end surfaces 58S6 and the lower end surfaces 58S5, in a state where the swing arm 84, accompanied by the T-shaped joint 88 and the discharge nozzle 32A, is rotated in a range of the circumferential angle larger than the predetermined circumferential angle in the case for the workpiece 58W4 about the rotational central axis line Oy in the directions opposite to each other, the discharge nozzles 32A to 32E simultaneously spray aerosolized particulates to the respective workpieces 58W5 at predetermined timing.

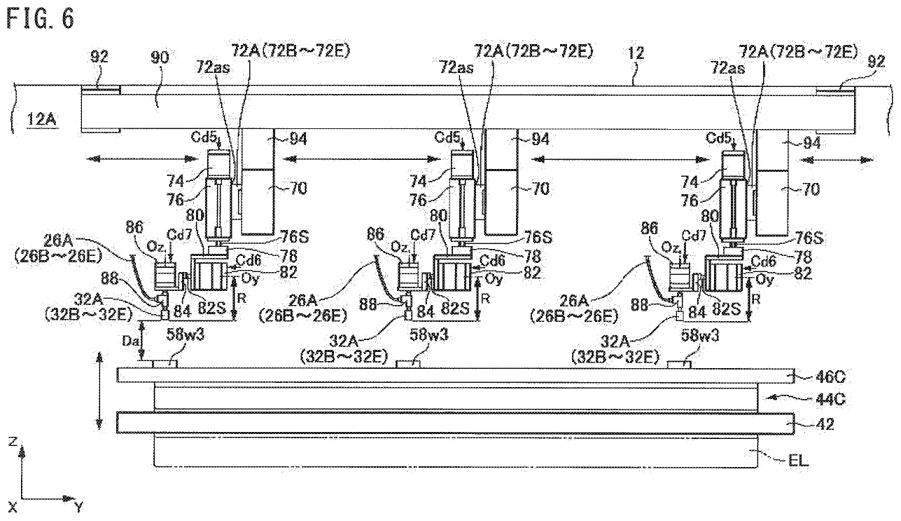

FIG. 6 is a configuration diagram schematically showing a main part of still another example of a deposition apparatus according to one or more embodiments of the present disclosure. Note that in FIG. 6, the same components as the components in the example shown in FIG. 3 are assigned the same symbols. Their redundant description is omitted. Note that in FIG. 6, the X-coordinate axis is configured to be parallel with the moving direction of a movable table of a lower stage 42, the Y-coordinate axis is configured to be orthogonal to the X-coordinate axis, and be parallel with the moving direction of a fixing table 46C coupled to a movable table of an upper stage 44C, described later. The Z-coordinate axis is configured to be orthogonal to the X-coordinate axis and the Y-coordinate axis.

In the example shown in FIG. 3, the single flat core linear motor (linear motor single-axis robot) 70 that includes the plurality of nozzle head mechanisms is arranged at the predetermined position. In the example shown in FIG. 6, flat core linear motors (linear motor single-axis robots) 70 including a plurality of nozzle head mechanisms are supported, at the opposite ends, at predetermined intervals by respective linear motor support sliders 94. Each linear motor support slider 94 is movably supported by a pair of guide rails 90 extending along the Y-coordinate axis in parallel with each other at a predetermined interval, for example. The opposite ends of the guide rails 90 are fixed to the inner circumference of the ceiling of the case 12 by a corresponding hook member 92.

In FIG. 6, for example, the mutual distance between the linear motor support sliders 94 is configured to correspond to the distance between a row of five workpieces 58W3 arranged in line on the fixing table 46C along the X-coordinate axis, and another row of the five workpieces 58W3 that is adjacent in the Y-coordinate direction to the aforementioned row and is arranged in line along the X-coordinate axis on the fixing table 46C. The rows of five workpieces 58W3 are arranged on the fixing table 46C at predetermined intervals along the Y-coordinate axis. The entire XY-axis stage is supported, for example, by an elevating mechanism EL as indicated by arrows so that the workpieces 58W3 can be close to or apart from the discharge ports of the respective discharge nozzles 32A to 32E. Thus, the distance between the discharge ports of the discharge nozzles 32A to 32E and the predetermined surfaces of the workpieces 58W3 is set to the predetermined distance Da. In this case, as shown in FIG. 5B, when the two upper end surfaces 58S6 of the workpiece 58W5 to be subjected to the surface treatment and the lower end surfaces 58S5 having the difference in height from the two upper end surfaces 58S6 are subjected to the surface treatment, fine adjustment of the positions of the discharge ports of the discharge nozzles 32A to 32E with respect to the lower end surfaces 58S5 may be performed by adjusting the position of the rod 76S of the electric cylinder 76 with the shaft guide in the nozzle head mechanism described above, for example.

Note that in the example described above, three rows of the linear motor support sliders 94 are arranged along the Y-coordinate axis. However, there is no limitation to such an example. For instance, four or more rows of linear motor support sliders 94 may be provided along the Y-coordinate axis in conformity with the number of workpieces.

Note that in the one example described above, as shown in FIG. 1, the directions of the discharge ports of the discharge nozzles 32A, 32B and 32C are configured to be the downward direction toward the cylindrical workpiece 58W1. However, there is no limitation to such an example. For example, in a case where a spiral V-shaped groove is formed on the outer circumferential surface of a cylindrical workpiece, the direction of the discharge port of the discharge nozzle 32A at the left end in FIG. 1 may be oriented diagonally downward right with respect to the workpiece, the direction of the discharge port of the discharge nozzle 32C at the right end may be oriented diagonally downward left with respect to the workpiece, and the direction of the discharge port of the discharge nozzle 32B at the center may be oriented directly downward. As described above, the directions of the discharge ports of the discharge nozzle 32A and the discharge nozzle 32C are set so as to face the inclined surfaces of the V-shaped groove. Accordingly, the surface treatment can be applied to the inclined surfaces of the spiral V-shaped groove formed on the outer circumferential surface of the workpiece.

In the example described above, the three discharge nozzles 32A, 32B and 32C are arranged in line along the X-coordinate axis. However, there is no limitation to such an example. Alternatively, four or more discharge nozzles may be arranged along the X-coordinate axis in a staggered manner. For example, two or more rows each including three discharge nozzles 32A, 32B and 32C may be arranged along the Y-coordinate axis. For example, the surface treatment may be applied to the workpieces 58W1 through six or nine discharge nozzles.

Furthermore, in the example described above, the workpieces are arranged at three sites between the Z-axis stage 48A and the Z-axis stage 48B. However, there is no limitation to such an example. For example, workpieces may be arranged at four or more sites between the Z-axis stage 48A and the Z-axis stage 48B described above.

Furthermore, in the example described above, the workpieces are supported at the opposite ends between the Z-axis stage 48A and the Z-axis stage 48B described above. However, there is no limitation to such an example. For example, in a case of a workpiece that is relatively short along the central axis line, the Z-axis stage 48B is not necessarily used, one end of the workpiece may be supported only by the Z-axis stage 48A, the workpiece may be supported in what is called a cantilevered manner, and the Z-axis stage 48A may be movably provided on the fixing table 46A along the X-coordinate axis.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A deposition apparatus, comprising:
discharge nozzles arranged at predetermined intervals in a processing compartment in a deposition chamber, wherein each of the discharge nozzles comprises a discharge port that discharges aerosolized particulates toward a corresponding surface treatment object;
linear motor single-axis robots arranged at predetermined intervals in a direction perpendicular to a nozzle arrangement direction; and
nozzle head units that each adjust a mutual distance between the discharge port and a surface of the corresponding surface treatment object based on a shape of the corresponding surface treatment object, wherein
the nozzle head units move along the nozzle arrangement direction, and
the nozzle head units are arranged in each of the linear motor single-axis robots.

2. The deposition apparatus according to claim 1, wherein
each of the linear motor single-axis robots extends in the nozzle arrangement direction,
each of the nozzle head units comprises:
an electric cylinder with a shaft guide;
a motor bracket;
a first stepping motor; and
a second stepping motor with a reducer,
the electric cylinder is supported by each of the linear motor single-axis robots movably in the nozzle arrangement direction,
a rod of the electric cylinder is coupled to an output shaft of the first stepping motor and is configured to elevate in a vertical direction of the deposition apparatus by an operation of the first stepping motor,
the motor bracket is coupled to a lower end of the rod,
the second stepping motor is supported by the motor bracket in a state where an output shaft of the second stepping motor is oriented in a direction orthogonal to the nozzle arrangement direction and the vertical direction, and
each of the nozzle head units changes a direction of the discharge port by rotating each of the discharge nozzles about the output shaft of the second stepping motor by the operation of the second stepping motor.

3. A deposition product manufacturing method, comprising:
arranging discharge nozzles at predetermined intervals in a processing compartment in a deposition chamber;
arranging nozzle head units that move along a nozzle arrangement direction in each of motor single-axis robots arranged at predetermined intervals in a direction orthogonal to the nozzle arrangement direction;
discharging, through a discharge port of each of the discharge nozzles, aerosolized particulates toward a corresponding surface treatment object; and
adjusting, by each of nozzle head units, a mutual distance between the discharge port and a surface of the corresponding surface treatment object depending on a shape of the corresponding surface treatment object.
